(19) United States
(12) Patent Application Publication
(10) Pub. No.: US 2026/0103135 A1
(43) Pub. Date: Apr. 16, 2026

(54) CONVEYOR SYSTEM AND VEHICLE INCLUDING SAME

(71) Applicants: Hyundai Motor Company, Seoul (KR); Kia Corporation, Seoul (KR)

(72) Inventors: Dae Hun Song, Hwaseong-si (KR); Hyuk Ho Kwon, Hwaseong-si (KR)

(21) Appl. No.: 19/063,595

(22) Filed: Feb. 26, 2025

(30) Foreign Application Priority Data
Oct. 11, 2024 (KR) 10-2024-0138698

(51) Int. Cl. B60P 1/52; B60P 1/12

(52) U.S. Cl. CPC B60P 1/52; B60P 1/12

(57) ABSTRACT

A conveyer system can include a first roller guiding cargo introduced to the inside of a vehicle body in a first direction, a first guide portion disposed parallel to a rotation axial direction of the first roller, and a second guide portion disposed adjacent to the first guide portion, wherein the first guide portion and the second guide portion guide a movement direction of the cargo guided in the first direction to a second direction intersecting the first direction.

### CROSS-REFERENCE TO RELATED APPLICATIONS

This application claims benefit of priority to Korean Patent Application No. 10-2024-0138698 filed on Oct. 11, 2024 in the Korean Intellectual Property Office, the disclosure of which is incorporated herein by reference in its entirety.

### TECHNICAL FIELD

The present disclosure relates to a conveyor system capable of loading cargo and a vehicle including the same.

### BACKGROUND

In the related art, in the process of transporting small cargo, a method in which a worker directly transported the cargo to the inside of a vehicle was generally used. This method may increase a physical burden on the worker depending on the size or weight of the cargo, and work time and labor consumption have been indicated as issues. In particular, the work of adjusting a loading position of the cargo requires additional manual work, and this may reduce efficiency in the process of transporting the cargo.

In addition, as autonomous driving technology has developed, the need for an unmanned transport system using the autonomous driving technology has emerged, and in the logistics and transportation industries, a technology that may automatically load cargo and automatically adjust the position of the loaded cargo without the intervention of a worker is required.

### SUMMARY

An embodiment of the present disclosure can provide a conveyor system that can automate the transport of cargo to a vehicle body and the appropriate adjustment of a position of the cargo inside the vehicle body.

According to an embodiment of the present disclosure, a conveyer system can include: a first roller guiding cargo introduced to the inside of a vehicle body in a first direction; a first guide portion disposed parallel to a rotation axial direction of the first roller; and a second guide portion disposed adjacent to the first guide portion, wherein the first guide portion and the second guide portion guide a movement direction of the cargo guided in the first direction to a second direction intersecting the first direction.

The conveyer system may further include: a first body portion in which the first roller, the first guide portion, and the second guide portion are arranged, wherein the first roller and the second guide portion are arranged on opposite sides with respect to the first guide portion.

The first guide portion and the second guide portion may be arranged in a rotationally symmetrical structure.

The first guide portion may include a first guide unit in which a guide roller is disposed, the first guide unit may be provided to be rotatable in a first axial direction as a rotation axial direction, and the first axial direction may intersect a rotation axial direction of the guide roller.

The second guide portion may include a second guide unit in which a guide roller is disposed, and the second guide unit may be provided to be rotatable in the first axial direction as a rotation axial direction.

The first guide portion may include a first driving unit rotating the first guide unit.

The first driving unit may include: a link portion; a rack gear connected to one end of the link portion; and a driving gear engaged with the rack gear, wherein the first guide unit may be coupled to the driving gear in a rotation axial direction of the driving gear.

The first guide unit may include a rotating gear, and the rotating gear may be coupled to the driving gear in the rotation axial direction of the driving gear.

The first guide unit may be provided in plural and may further include a chain connecting the rotating gear disposed in the plurality of first guide units.

The link portion may move the rack gear in a longitudinal direction of the rack gear.

According to an embodiment of the present disclosure, a vehicle can include: a vehicle body; and a conveyor system disposed on the inside of the body, wherein the conveyor system guides cargo introduced to the vehicle body in a first direction to a second direction intersecting the first direction.

The conveyor system may include: a first roller guiding the cargo in the first direction; a first guide portion disposed parallel to a rotation axial direction of the first roller; and a second guide portion disposed adjacent to the first guide portion.

### BRIEF DESCRIPTION OF THE DRAWINGS

The features and advantages of example embodiments of the present disclosure can be more clearly understood from the following detailed description, taken in conjunction with the accompanying drawings, in which:

FIG. 1 illustrates a conveyor system according to an embodiment of the present disclosure;

FIG. 2 conceptually illustrates the use of a conveyor system according to an embodiment of the present disclosure;

FIG. 3 is a perspective view illustrating a closed state of a conveyor system according to an embodiment of the present disclosure;

FIG. 4 is a top view of a cut-out portion of FIG. 3;

FIG. 5 is a side view of a cut-out portion of FIG. 3;

FIG. 6 illustrates an operation of a second body portion of a conveyor system according to an embodiment of the present disclosure;

FIG. 7 has enlarged views of driving unit components of a conveyor system according to an embodiment of the present disclosure;

FIG. 8 is a top view of area A of FIG. 7;

FIG. 9 is a top view of area B of FIG. 7;

FIG. 10 is a perspective view illustrating a guide portion of a conveyor system according to an embodiment of the present disclosure;

FIG. 11 is a top view of the guide portion of FIG. 10, with a portion of the guide portion omitted;

FIG. 12 illustrates a first guide unit, according to an embodiment of the present disclosure;

FIG. 13 illustrates portion C of FIG. 10;

FIG. 14 is a bottom perspective view of FIG. 13; and

FIG. 15 is a bottom plan view of FIG. 13.

### DETAILED DESCRIPTION OF ILLUSTRATIVE EMBODIMENTS

While an embodiment of the present disclosure may be modified in various ways and take on various alternative forms, specific example embodiments are shown in the drawings and described in detail below. However, it can be understood that there is no intent to necessarily limit the present disclosure to the particular forms disclosed, but on the contrary, an embodiment of the present disclosure can include modifications, equivalents, and alternatives falling within the spirit and scopes of the present disclosure.

It can be understood that, although the terms “first,” “second,” etc. may be used herein to describe various elements, these elements are not necessarily limited by these terms. These terms can be used merely to distinguish one element from another. For example, a first element could be termed a second element, and a second element could similarly be termed a first element without departing from the scopes of the present disclosure. As used herein, the term “and/or” includes any and all combinations of one or more of the associated listed items.

The terms, such as “unit, part, portion, etc. ” may be used to describe various components, but the components are not necessarily limited by these terms. These terms may refer to not only physically/visually distinct components, but also to functions or components of a portion even if the corresponding portion is not clearly divided.

Terms used herein to describe example embodiments of the present disclosure are not intended to necessarily limit the scope of the present disclosure. The articles “a,” and “an” are singular in that they have a single referent, however the use of the singular form in the present document should not preclude the presence of more than one referent. In other words, elements of an example embodiment of the present disclosure referred to in the singular may number one or more, unless the context clearly indicates otherwise. It can be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different manner, terms used herein, including technical and scientific terms, can have same meanings as understood by those skilled in the art to which the present disclosure pertains. Such terms as defined in generally used dictionaries can be construed to have same meanings as those of the contexts of the related art.

In this specification, vehicles can refer to a variety of vehicles that move transported objects, such as people, animals, or goods, from a starting point to a destination. These vehicles are not limited to vehicles that run on roads or tracks. Vehicles can include not only those that use fossil fuels, such as gasoline, but also those that use electricity stored in batteries or the like and those that use future fuels, such as hydrogen.

In the description below, the terms “anterior,” “posterior,” “lateral,” “front,” “rear,” “up/down,” “above,” “upper,” “top,” “below,” “lower,” “bottom,” “left/right,” and the like can be defined based on a vehicle or vehicle body. Terms, such as “first” and “second” may be used to describe various components, but these components are not necessarily limited in order, size, location, or importance by terms, such as “first” and “second” and can be named for the sole purpose of distinguishing one component from another.

Example embodiments of the present disclosure are described in detail with reference to the accompanying drawings.

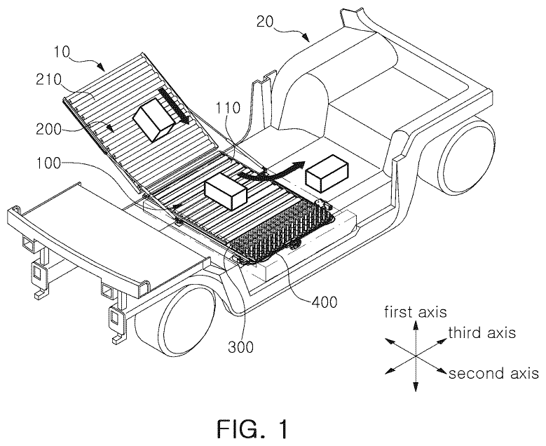

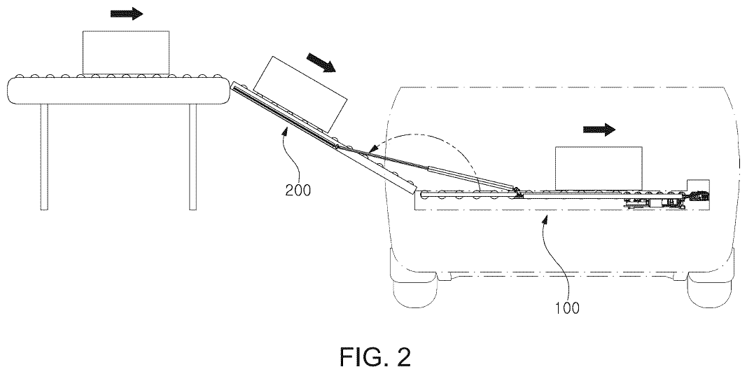

Referring to FIGS. 1 and 2, a conveyor system 10 according to an embodiment of the present disclosure may be disposed on a body 20 of the vehicle. The conveyor system 10 may be disposed inside the body 20 of the vehicle and may be coupled to an inner bottom portion of the body 20.

Based on the state of use of the conveyor system 10, a portion of the conveyor system 10 may be disposed inside the body 20, and another portion of the conveyor system 10 may be exposed to the outside of the body 20. Specifically, the conveyor system 10 may include a first body portion 100 and a second body portion 200. One side of the first body portion 100 and one side of the second body portion 200 may be hinge-coupled. The second body portion 200 may be provided to be rotatable with respect to the first body portion 100. The first body portion 100 of the conveyor system 10 may be disposed on the inside of the body 20 and may be coupled to the body 20. The second body portion 200 of the conveyor system 10 may be exposed on the outside of the body 20 and may form a slope. The slope formed by the second body portion 200 may be a slope in which a distance from the ground becomes closer as it goes from the outside of the body 20 to the inside of the body 20.

The conveyor system 10 may move cargo supplied from the outside of the vehicle to the inside of the vehicle. Specifically, a first roller 110 can be disposed on the first body portion 100. The first roller 110 may be provided in plural. A rotation axial direction of the first roller 110 may be parallel to a rotation axial direction in which the second body portion 200 rotates relative to the first body portion 100. The plurality of first rollers 110 may be arranged parallel to each other, and there is no particular limitation on the number thereof.

A second roller 210 can be disposed on the second body portion 200. A rotation axial direction of the second roller 210 may be parallel to the rotation axial direction of the first roller 110. The second roller 210 may be provided in plural. The plurality of second rollers 210 may be arranged parallel to each other, and there is no particular limitation on the number thereof.

The cargo transported by the conveyor system 10 by an external source or worker can move downward along the second body portion 200 to reach the first body portion 100 and can move in a first direction through the first roller 110 of the first body portion 100. The first direction may refer to a direction from the outside of the body 20 toward the inside of the body 20. The cargo moving in the first direction from the first body portion 100 can be guided in a second direction intersecting the first direction by a first guide portion 300. However, the cargo may be guided in a third direction, which can be the opposite direction to the second direction, through the operation of the first guide portion 300 and the second guide portion 400 arranged in the first body portion 100.

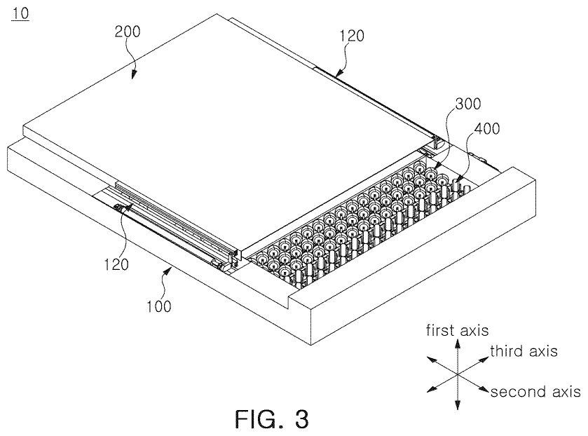

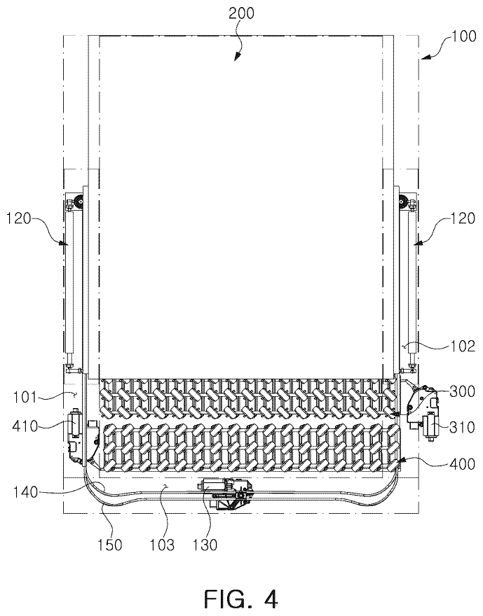

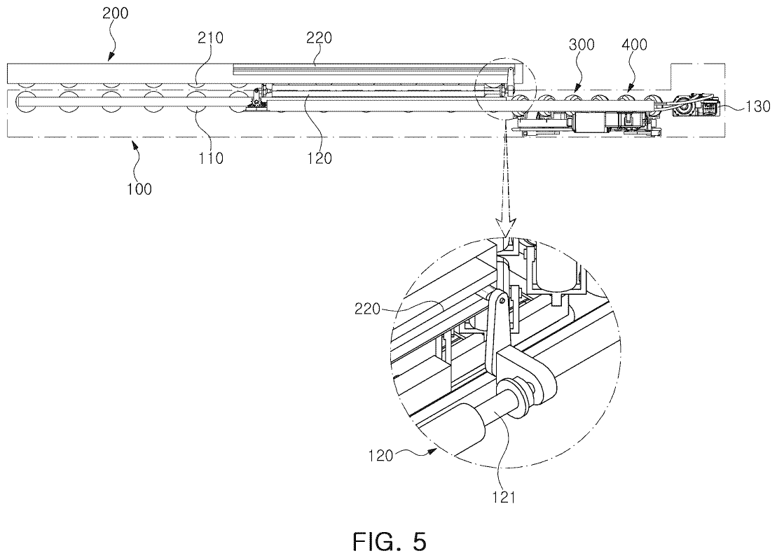

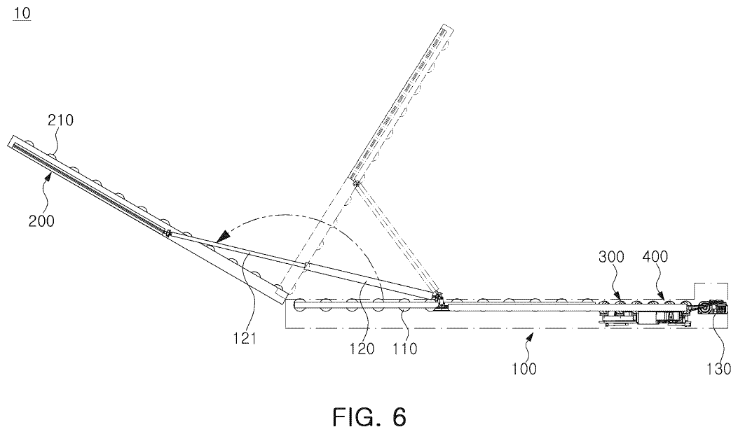

Hereinafter, a structure of the conveyor system 10 of an example embodiment will be specifically described. FIG. 3 is a perspective view illustrating a closed state of a conveyor system 10 according to an embodiment of the present disclosure. FIG. 4 is a top view of a cut-out portion of FIG. 3. FIG. 5 is a side view of the cut-out portion of FIG. 3. FIG. 6 is a side view illustrating an operation of opening the second body portion 200 of the conveyor system 10 according to an embodiment of the present disclosure. The width and/or length of the first body portion 100 may be formed to be larger than the width and/or length of the second body portion 200. That is, based on the closed state of the second body portion 200, the second body portion 200 may be disposed to overlap a portion of the first body portion 100 in a first axial direction.

The conveyor system 10 may include a driving unit provided to rotate the second body portion 200. The driving unit may include a lift 120, wires 140 and 150, a power portion 130, and gears. Each component of the driving unit may be arranged in the first body portion 100, and in particular, may be arranged along the inner edge of the first body portion 100. Specifically, the inner edge of the first body portion 100 may be divided into a first edge region 101, a second edge region 102, and a third edge region 103. The first edge region 101 and the second edge region 102 may refer to regions spaced apart in the width direction (a third axial direction) of the first body portion 100. That is, the first edge region 101 and the second edge region 102 may refer to regions arranged parallel to the longitudinal direction (second axial direction) of the first body portion 100. The third edge region 103 may refer to a region arranged toward the longitudinal end of the first body portion 100. That is, the third edge region 103 can be disposed between the first edge region 101 and the second edge region 102 and may connect the first edge region 101 to the second edge region 102.

The lift 120 may be provided in plural, and in such configuration, one of the plurality of lifts 120 may be disposed in the first edge region 101 and the other may be disposed in the second edge region 102. One side of the lift 120 may be disposed to be rotatable in the first body portion 100, and the other side of the lift 120 may be disposed in the second body portion 200. A guide rail 220 may be disposed on a side surface of the second body portion 200. The guide rail 220 may be disposed in a longitudinal direction of the second body portion 200. The other side of the lift 120 may be coupled to the second body portion 200 to be movable along the side surface of the second body portion 200 by the guide rail 220.

Referring to FIG. 6, the second body portion 200 may be opened and closed by the rotation of the lift 120. Referring to FIG. 6, when one side of the lift 120 can be coupled to the first body portion 100 and can rotate counterclockwise, the second body portion 200 can be coupled to the first body portion 100 and can rotate, and the other side of the lift 120 can slide along the guide rail 220 of the second body portion 200 and can rotate within a predetermined range with respect to the second body portion 200. The other side of the lift 120 can move from the far side to the near side based on a portion in which the first body portion 100 and the second body portion 200 are hingedly coupled. Thereafter, when the lift 120 rotates further counterclockwise, a piston rod 121 of the lift 120 can be pulled out and the length of the lift 120 can increase, the other side of the lift 120 can rotate with respect to the second body portion 200, and the second body portion 200 also can rotate further counterclockwise to form a slope. When the second body portion 200 rotates with respect to the first body portion 100 by a hinge connection, the first body portion 100 and the second body portion 200 may rotate relative to each other with respect to the lift 120.

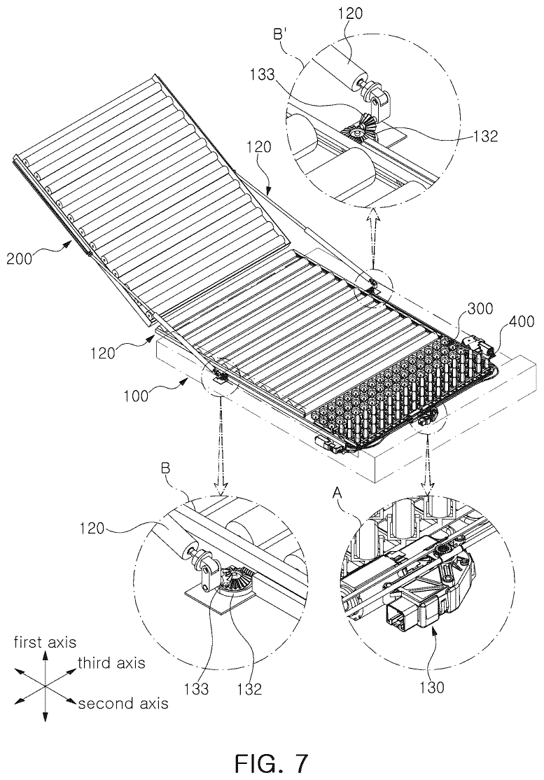

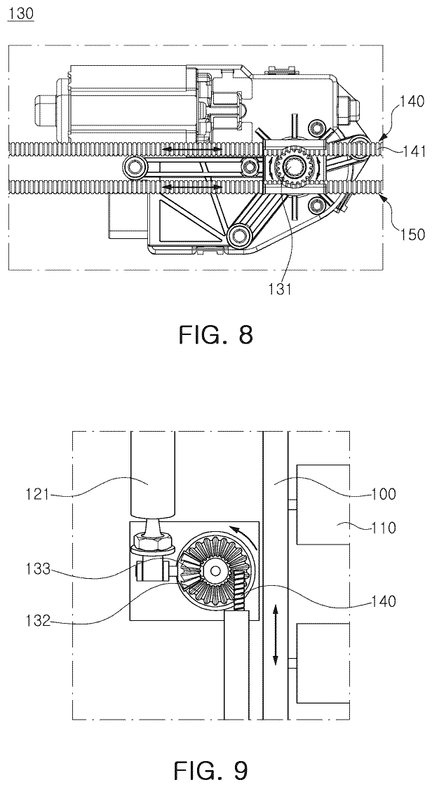

FIG. 7 is an enlarged view of the driving unit components of the conveyor system 10, of an example embodiment. FIG. 8 is a top view of area A of FIG. 7. FIG. 9 is a top view of area B of FIG. 7. In FIG. 7, zoomed in areas B and B′ are respectively provided, but areas B and B′ can include substantially the same components, respectively. Referring to FIGS. 7 to 9, the driving unit may include the power portion 130 and a plurality of gears and wires 140 and 150.

Referring to FIG. 8, the power portion 130 may include a motor. The power portion 130 may transmit rotational power of the motor to a first gear 131. The first gear 131 may be a spur gear. The wires 140 and 150 may be mechanically coupled to the first gear 131. Specifically, a plurality of protrusions 141 may be repeatedly arranged on the surface of the wires 140 and 150. The plurality of protrusions 141 may be engaged with teeth of a gear. Therefore, the wires 140 and 150 may be engaged with the first gear 131, and the wires 140 and 150 may move as the first gear 131 rotates. The wires 140 and 150 may include a first wire 140 and a second wire 150. The first wire 140 may refer to a wire providing rotational force to any one of the first lift 120 or the second lift 120, and the second wire 150 may refer to a wire providing rotational force to the other of the first lift 120 or the second lift 120.

Referring to FIG. 8, if the wire disposed at the top is referred to as the first wire 140 and the wire disposed at the bottom is referred to as the second wire 150, when the first gear 131 rotates clockwise, the first wire 140 can move to the right and the second wire 150 can move to the left. Conversely, when the first gear 131 rotates counterclockwise, the first wire 140 can move to the left and the second wire 150 can move to the right. Referring back to FIG. 4, the first wire 140 and the second wire 150 can be arranged across the first to third inner edge regions 103 of the first body portion 100. Because the plurality of protrusions 141 that may be engaged with the gears can be arranged on the surface of the wires 140 and 150, when another gear is engaged with the wires 140 and 150 that flows or moves by the rotation of the first gear 131, the other gear may rotate by the flow or movement of the wires 140 and 150.

Referring to FIG. 9, a gear is disposed in the first body portion 100. The gear disposed in the first body portion 100 may be referred to as a second gear 132. The second gear 132 may be rotatably disposed in the first body portion 100. The gear may be referred to as a second gear 132. The second gear 132 may be a bevel gear. The second gear 132 may be mechanically coupled to the wires 140 and 150. That is, the second gear 132 may be engaged with the wires 140 and 150. Therefore, when the first wire 140 flows or moves, the second gear 132 may rotate.

As described above, one side of the lift 120 can be rotatably disposed on the first body portion 100. For the rotation of the lift 120, a gear can be coupled to one side of the lift 120. The gear coupled to one side of the lift 120 may be referred to as a third gear 133. The third gear 133 may be a bevel gear. The third gear 133 may be engaged with the second gear 132. Therefore, as the third gear 133 rotates, the second gear 132 may also rotate, and because the second gear 132 and the third gear 133 are bevel gears, respective rotation axes thereof may be disposed orthogonally.

Hereinafter, cargo transport of the conveyor system 10 according to an example embodiment of the present disclosure is described. When the vehicle moves or cargo is not loaded, the conveyor system 10 may be in a partially closed state or a closed state. The closed state of the conveyor system 10 may refer to a state in which the second body portion 200 is disposed to face the first body portion 100. More specifically, it may refer to a state in which the second body portion 200 faces the first body portion 100 and is disposed parallel to each other.

When cargo loading is required, the conveyor system 10 may be in an open state. The open state may refer to a state in which the second body portion 200 rotates to form a slope. Because one side of the second body portion 200 can be hinge-coupled to the first body portion 100, the second body portion 200 may rotate to form a slope.

To rotate the second body portion 200, the first gear 131 of the power portion 130 first can rotate. As the first gear 131 rotates, the wires 140 and 150 engaged with the first gear 131 can move. As the wires 140 and 150 move, the second gear 132 engaged with the wires 140 and 150 can rotate, the third gear 133 engaged with the second gear 132 may also rotate, and the lift 120 coupled to the third gear 133 can rotate. One end of the lift 120 can be coupled to the third gear 133, and the other end of the lift 120 can be movably coupled to a guide rail 220 disposed on the side surface of the second body portion 200.

Therefore, as the lift 120 rotates while being coupled to the first body portion 100, the other end of the lift 120 can move along the guide rail 220 and can rotate with respect to the second body portion 200, and as a rotation range of the lift 120 increases, the piston rod 121 of the lift 120 can be pulled out and the length of the lift 120 can increase. For the conveyor system 10 to be in a closed state, the process can be performed in reverse.

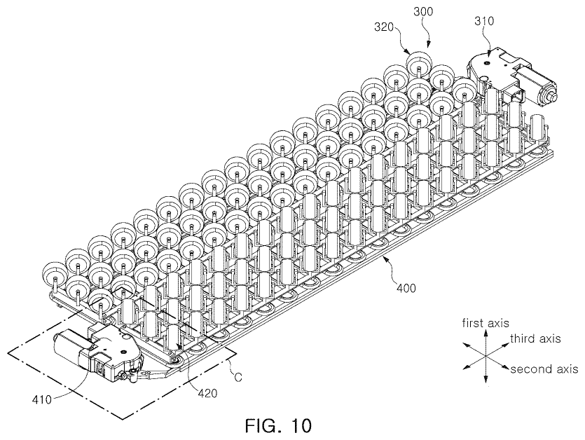

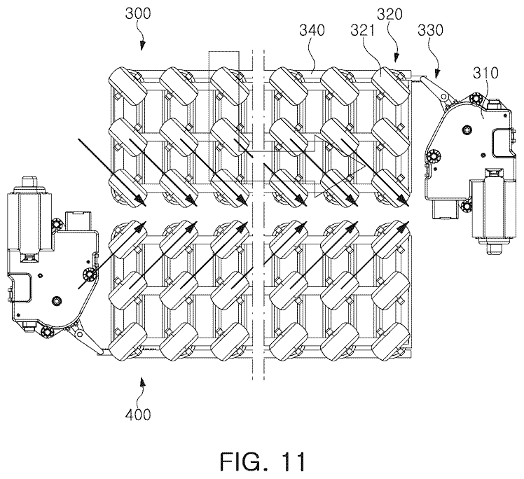

Hereinafter, a cargo sorting system provided in the conveyor system, according to an example embodiment of the present disclosure, will be described. FIG. 10 is a perspective view illustrating a guide portion of the conveyor system of an example embodiment. FIG. 11 is a top view of the guide portion of FIG. 10, with a portion of the guide portion omitted.

The cargo sorting system can include a guide portion. The guide portion may include a first guide portion 300 and a second guide portion 400. The first guide portion 300 and the second guide portion 400 can include substantially the same configuration.

The first guide portion 300 and the second guide portion 400 may be disposed adjacent to each other. The first guide portion 300 and the second guide portion 400 may be disposed parallel. The first guide portion 300 and the second guide portion 400 may be disposed parallel to each other in the longitudinal direction. The first guide portion 300 and the second guide portion 400 may be disposed to be rotationally symmetrical (or can be mirror symmetrical).

Referring back to FIG. 7, the first guide portion 300 and the second guide portion 400 can be arranged in the first body portion 100. The first guide portion 300 can be disposed parallel to a rotational axis of the first roller 110. The second guide portion 400 can be disposed parallel to the first guide portion 300. The second guide portion 400 may be disposed on the opposite side of the first roller 110 with the first guide portion 300 there between.

A guide unit may be disposed on the first guide portion 300. The guide unit disposed on the first guide portion 300 may be referred to as a first guide unit 320. The first guide unit 320 may be disposed in plural. The plurality of first guide units 320 may be disposed in parallel with each other. The first guide unit 320 may rotate in a first axial direction as a rotation axial direction, and the plurality of first guide units 320 may all rotate in the first axial direction as a rotation axial direction. That is, the first guide units 320 can be mechanically connected to each other and may rotate together in the first axial direction as a rotation axial direction. The first axial direction may be a direction intersecting the longitudinal direction of the first guide portion 300. More specifically, the first axial direction may be a direction perpendicular to the longitudinal direction of the first guide portion 300.

A guide unit may be disposed in the second guide portion 400. The guide unit disposed in the second guide portion 400 may be referred to as a second guide unit 420. The second guide unit 420 may be disposed in plural. The plurality of second guide units 420 may be disposed in parallel with each other. The second guide unit 420 may rotate in the first axial direction as a rotation axial direction, and the plurality of second guide units 420 may all rotate in the first axial direction as a rotation axial direction. That is, the second guide units 420 may be mechanically connected to each other and may rotate together in the first axial direction as a rotation axial direction. Here, the first axial direction may be a direction intersecting the longitudinal direction of the second guide portion 400. More specifically, the first axial direction may be a direction perpendicular to the longitudinal direction of the second guide portion 400. Hereinafter, for the convenience of description, the rotation in the first axial direction as a rotation axial direction is referred to as a first axis rotation.

The first guide unit 320 and the second guide unit 420 can include guide rollers to be described below. The first guide unit 320 and the second guide unit 420 can rotate in the first axial direction to adjust a circumferential direction of the guide rollers 321 and 421, thereby guiding a movement direction of the cargo.

Referring to FIG. 11, the circumferential direction of the first guide roller 321 and the circumferential direction of the second guide roller 421 can be arranged to intersect each other. Specifically, a virtual line extending the circumferential direction of the first guide roller 321 and a virtual line extending the circumferential direction of the second guide roller 421 can be arranged in a direction intersecting each other, and they can become closer to each other as they move from one side of the first guide roller 321 or the second guide roller 421 to the other side thereof. However, the first guide roller 321 and the second guide roller 421 may be arranged opposite to FIG. 11 by the first axis rotation.

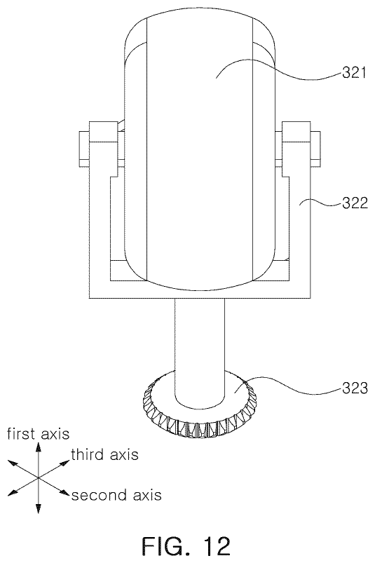

FIG. 12 illustrates the first guide unit. The second guide unit 420 can be the same as the first guide unit 320, so a description of the second guide unit 420 can be replaced with the description of the first guide unit 320. The first guide unit 320 may include a first guide roller 321, a first frame 322, and a first rotating gear 323. The first guide roller 321 may be rotatably coupled to the first frame 322. A rotation axis of the first guide roller 321 may be disposed to intersect the first axial direction. More specifically, the rotation axis of the first guide roller 321 may be orthogonal to the first axial direction. According to FIG. 12, the first guide roller 321 can have a wheel-like shape. However, unlike the first guide roller 321 illustrated in FIG. 12, the first guide roller 321 may be provided in the shape of a ball.

The first rotating gear 323 can be disposed at one end of the first frame 322. The first frame 322 and the first rotating gear 323 may be directly coupled. The first frame 322 and the first rotating gear 323 may also be coupled through another member. A rotation axis of the first rotating gear 323 can be an axis parallel to the first axial direction, and the first frame 322 may also rotate while sharing the rotation axis of the first rotating gear 323 according to the rotation of the first rotating gear 323.

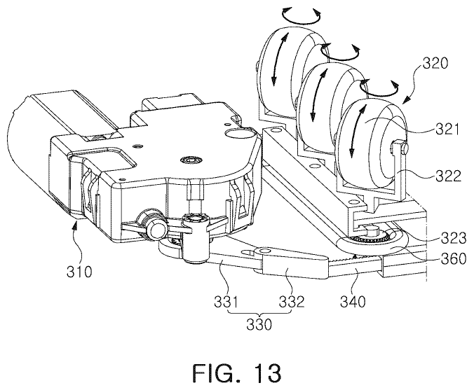

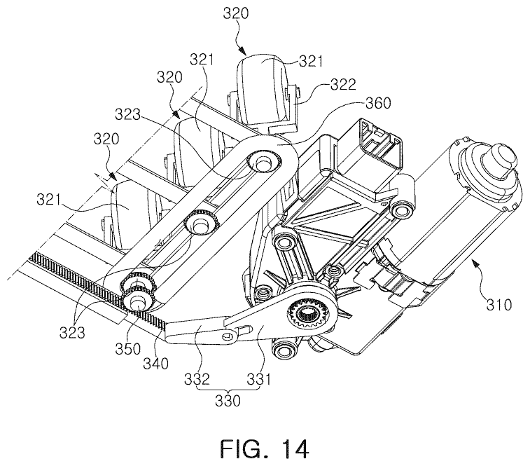

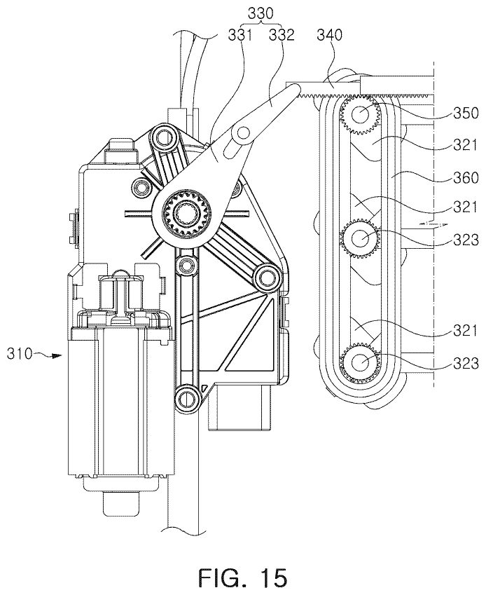

FIG. 13 illustrates portion C of FIG. 10. FIG. 14 is a bottom perspective view of FIG. 13. FIG. 15 is a bottom plan view of FIG. 13. A driving unit provided in the first guide portion 300 will be described with reference to FIGS. 13 to 15. Because the second guide portion 400 can include the same configuration as the first guide portion 300, a description related to the second guide portion 400 can be replaced with the description of the first guide portion 300.

The first guide portion 300 can include a driving unit. The driving unit of the first guide portion 300 may be referred to as a first driving unit. The first driving unit may include a first power portion 310, a first link portion 330, a first rack gear 340, and a first driving gear 350.

The first power portion 310 may be disposed on one side or the other side of the first guide portion 300. The first power portion 310 may be disposed in the first edge region 101 or the second edge region 102 of the first body portion 100. The first power portion 310 may include a motor as a power device.

One side of the first link portion 330 may be disposed in the first power portion 310. The first link portion 330 may include a first rotation link 331 and a first traction link 332. The first rotation link 331 and the first traction link 332 may be hinge-coupled. The first rotation link 331 may be coupled to the first power portion 310. The first rotation link 331 may be rotated by the first power portion 310. The first traction link 332 may be hinge-coupled to the first rack gear 340 to be described below. The first rotation link 331 and the first traction link 332 can be hinge-coupled, and the first traction link 332 and the first rack gear 340 can be also hinge-coupled. Therefore, when the first rotation link 331 rotates through this coupling structure, the first rack gear 340 may move in the longitudinal direction of the first rack gear 340.

The first rack gear 340 may be disposed in the longitudinal direction of the first guide portion 300. The first rack gear 340 may move in the longitudinal direction of the first rack gear 340 by the first link portion 330, and the plurality of first guide units 320 described above may be rotated by the movement of the first rack gear 340.

The first driving gear 350 may be coupled to the first guide unit 320. Specifically, the first driving gear 350 may be coupled to the first rotating gear 323 of the first guide unit 320. The first driving gear 350 and the first rotating gear 323 may be disposed in parallel. In this case, the rotation axis of the first driving gear 350 and the rotation axis of the first rotating gear 323 may be the same axis. Therefore, when the first driving gear 350 rotates, the first rotating gear 323 also can rotate around the same rotation axis.

The first driving gear 350 may be engaged with the first rack gear 340. Therefore, when the first rack gear 340 moves in the longitudinal direction of the first rack gear 340, the first driving gear 350 may rotate.

The first guide unit 320 can be provided in plural. The first driving gear 350 may be disposed in some of the plurality of first guide units 320. Specifically, the first driving gear 350 may be disposed in the first guide unit 320 disposed adjacent to the first rack gear 340 among the plurality of first guide units 320.

Referring to FIGS. 13 to 15, some of the plurality of first guide units 320 may be arranged in a width direction of the first guide portion 300 and may be mechanically coupled through a chain 360. The chain 360 may be engaged with the first rotating gear 323 disposed on the first guide unit 320. Therefore, when the first rotating gear 323 of any one of the plurality of first guide units 320 mechanically coupled through the chain 360 rotates, the other first guide unit 320 may also rotate in the same direction through the chain 360.

The first driving gear 350 can be disposed on the first guide unit 320 adjacent to the first rack gear 340 among the plurality of first guide units 320. When the first driving gear 350 is rotated by the first rack gear 340, the first guide unit 320 coupled to the first driving gear 350 can rotate and the first rotating gears connected through the chain 360 may also rotate. Through this structure, a plurality of first guide units 320 may rotate together.

Referring back to FIGS. 1, 2, 10, and 11, the operation of the conveyor system according to an embodiment of the present disclosure will be described. The cargo transported from the outside of the body 20 to the conveyor system 10 can pass sequentially through the second body portion 200 and the first body portion 100 in the first direction (parallel to the second axis of FIG. 1) due to the slope formed by the second body portion 200. Because the first guide roller 321 of the first guide portion 300 can be disposed so that a rotation axis thereof intersects the rotation axis of the first guide roller 321, the cargo can be guided to move in the second direction (parallel to the third axis of FIG. 1) intersecting the first direction by the first guide portion 300. In this example, because the second guide roller 421 of the second guide portion 400 can be disposed so that a rotation axis thereof intersects the first guide roller 321, the effect of restricting the cargo from moving in the first direction can be obtained. If the movement of the cargo is intended to be guided in the third direction opposite to the second direction, the rotation axes of the first guide roller 321 and the second guide roller 421 may be adjusted to become closer as they move in the third direction by rotating the first guide unit 320 and the second guide unit 420.

According to the conveyor system and the vehicle including the same of an embodiment of the present disclosure, even if it is an unmanned vehicle without a driver, cargo may be easily transported from the outside to the inside of the vehicle and a loading position of the cargo may be adjusted as needed inside the vehicle.

According to the conveyor system of an embodiment of the present disclosure, there is an advantage in that the transfer and sorting of cargo from the outside to the vehicle body can be automated.

While example embodiments have been shown and described above, it can be apparent to those skilled in the art that modifications and variations could be made without departing from the scopes of the present disclosure as defined by the appended claims.

What is claimed is:

1. A conveyer system comprising:
a first roller configured to guide a cargo introduced to an inside of a vehicle body in a first direction;
a first guide portion disposed parallel to a rotation axial direction of the first roller; and
a second guide portion disposed adjacent to the first guide portion, wherein the first guide portion and the second guide portion are configured to guide a movement direction of the cargo guided in the first direction to a second direction intersecting the first direction.

2. The conveyer system of claim 1, further comprising a first body portion in which the first roller, the first guide portion, and the second guide portion are arranged, wherein the first roller and the second guide portion are arranged on opposite sides with respect to the first guide portion.

3. The conveyer system of claim 1, wherein the first guide portion and the second guide portion are arranged in a rotationally symmetrical structure relative to each other.

4. The conveyer system of claim 1, wherein the first guide portion includes a first guide member, wherein the first guide member includes a first guide roller disposed therein, wherein the first guide member is configured to be rotatable in a first rotation axial direction, and wherein the first rotation axial direction intersects a second rotation axial direction of the first guide roller.

5. The conveyer system of claim 4, wherein the second guide portion includes a second guide member, wherein the second guide member includes a second guide roller disposed therein, and wherein the second guide member is provided to be rotatable in the first rotation axial direction.

6. The conveyer system of claim 4, wherein the first guide portion includes a first driving system configured to rotate the first guide member.

7. The conveyer system of claim 6, wherein the first driving system includes:
a link portion;
a rack gear connected to a first end of the link portion; and
a driving gear engaged with the rack gear, wherein the first guide member is coupled to the driving gear in a driving-gear rotation axial direction of the driving gear.

8. The conveyer system of claim 7, wherein the first guide member includes a rotating gear, wherein the rotating gear is coupled to the driving gear in the driving-gear rotation axial direction of the driving gear.

9. The conveyer system of claim 8, wherein the first guide member is provided in a plurality and further includes a chain connecting the rotating gear disposed in the plurality of the first guide member.

10. The conveyer system of claim 7, wherein the link portion is configured to move the rack gear in a rack-gear longitudinal direction of the rack gear.

11. A vehicle comprising:
a vehicle body; and
a conveyor system disposed on an inside of the vehicle body, wherein the conveyor system is configured to guide a cargo introduced into the vehicle body in a first direction to a second direction intersecting the first direction.

12. The vehicle of claim 11, wherein the conveyor system comprises:
a first roller configured to guide the cargo in the first direction;
a first guide portion disposed parallel to a rotation axial direction of the first roller; and
a second guide portion disposed adjacent to the first guide portion.

13. A vehicle comprising:
a vehicle body having a cargo area with a floor; and
a conveyor system attached to the floor of the cargo area, wherein the conveyor system comprises:
a first body portion located in the cargo area,
a first set of rollers on a first side of the first body portion, wherein the first set of rollers is configured to assist movement of a cargo along the first set of rollers in a first direction from outside the cargo area toward inside the cargo area,
a first direction-change guide portion in the first body portion, wherein the first direction-change guide portion is adjacent the first set of rollers, and wherein the first direction-change guide portion includes a first set of rotatable guide members, and
a second direction-change guide portion on a second side of the first body portion, wherein the first direction-change guide portion is disposed between the second direction-change guide portion and the first set of rollers, wherein the second direction-change guide portion includes a second set of rotatable guide members, and wherein the first set of rotatable guide members and the second set of rotatable guide members are configured to be selectively oriented to assist and guide movement of the cargo in a second direction that intersects the first direction.

14. The vehicle of claim 13, wherein the first set of rotatable guide members are configured to be selectively oriented at a first guide member angle, wherein the second set of rotatable guide members are configured to be selectively oriented at a second guide member angle, such that the first guide member angle is mirror symmetrical with the second guide member angle.

15. The vehicle of claim 13, wherein the conveyor system further comprises first drive system including rotation gears and a motor,
wherein the first set of rotatable guide members are configured to be selectively oriented at a first guide member angle by the first drive system, and
wherein the first drive system is configured to rotate the first set of rotatable guide members to the first guide member angle by the motor via the rotation gears.

16. The vehicle of claim 15, wherein the first drive system comprises a link portion, and wherein the rotation gears of the first drive system comprise:
a rack gear connected to a first end of the link portion; and
a driving gear engaged with the rack gear, wherein the first set of rotatable guide members are coupled to the driving gear in a driving-gear rotation axial direction of the driving gear.

17. The vehicle of claim 16, wherein the first drive system comprises a chain connecting a set of coordination gears coupled to the first set of rotatable guide members, such that the first set of rotatable guide members can be moved in unison together.

18. The vehicle of claim 13, wherein the conveyor system further comprises:
a second body portion pivotably coupled to the first body portion; and
a second set of rollers in the second body portion, wherein the second set of rollers is configured to assist movement of the cargo in the first direction toward the first set of rollers.

19. The vehicle of claim 18, wherein the conveyor system is configured so that the second body portion can be extended outside the cargo area with a slope downward towards the first body portion.

20. The vehicle of claim 19, wherein the conveyor system is configured so that the second body portion can be folded into the cargo area and stored in the cargo area.
